(19) United States
(12) Patent Application Publication
(10) Pub. No.: US 2026/0220902 A1
(43) Pub. Date: Jul. 30, 2026

(54) ENHANCED AVATARS USING MULTIMODAL INPUTS

(71) Applicant: Bytedance Technology Ltd., Grand Cayman (KY)

(72) Inventors: Kin Chung Wong, Los Angeles, CA (US); Yixin Zhao, CULVER CITY, CA (US); Yue Chen, Beijing (CN); Zichun Wang, CULVER CITY, CA (US); Thomas Viking Oefverstroem, SINGAPORE (SG); Siyuan Chen, CULVER CITY, CA (US); Shuanglin Zhao, CULVER CITY, CA (US); Xin Lu, Los Angeles, CA (US); Linjie Luo, Los Angeles, CA (US); Siqi Tan, CULVER CITY, CA (US)

(21) Appl. No.: 19/038,611

(22) Filed: Jan. 27, 2025

(51) Int. Cl. G06T 19/20; G06T 13/40; G06T 15/02

(52) U.S. Cl. CPC G06T 19/20; G06T 13/40; G06T 15/02; G06T 2200/24; G06T 2210/16; G06T 2219/2024

(57) ABSTRACT

The present disclosure involves methods, apparatus, and systems for generating enhanced avatars. this can include receiving an input from a user requesting an enhanced avatar; providing the input to a first generative AI model that is configured to output a standardized prompt based on the input; receiving, from the first generative AI model, the standardized prompt; identifying a baseline avatar associated with the user; and providing the baseline avatar and the standardized prompt to an enhancement workflow to generate an enhanced avatar based on the standardized prompt and the baseline avatar.

### TECHNICAL FIELD

The present disclosure generally relates to generating enhanced user avatars using multimodal inputs to one or more generative artificial intelligences (AIs).

### BACKGROUND

Digital avatars are increasingly popular on social media and other internet-based platforms. They can be created using various methods, such as photorealistic rendering or 3D modeling. These avatars can represent users in a variety of ways, from simple cartoonish characters to highly realistic representations. Digital avatars can be used in a variety of ways, such as for profile pictures, to create personalized reactions (e.g., personalized emojis), or even to represent users in virtual worlds and games.

### SUMMARY

The present disclosure relates to a method, system, and computer-readable storage media for enhancing digital avatars. This can include receiving an input from a user requesting an enhanced avatar; providing the input to a first generative AI model that is configured to output a standardized prompt based on the input; receiving, from the first generative AI model, the standardized prompt; identifying a baseline avatar associated with the user; and providing the baseline avatar and the standardized prompt to an enhancement workflow to generate an enhanced avatar based on the standardized prompt and the baseline avatar.

Implementations can optionally include one or more of the following features.

In some instances, the enhancement workflow includes a second generative AI model configured to provide the enhanced avatar as an image.

In some instances, the second generative AI model is a diffusion model and the enhancement workflow comprises: a low-rank adaptation (LoRA) model configured to provide stylization information to the second generative AI model; a ControlNet model configured to condition the diffusion model to generate a particular pose based on the standardized prompt and the baseline avatar; and a third generative AI model configured to repaint faces generated by second generative AI model, wherein the third generative AI model is a diffusion model.

In some instances, generating an enhanced avatar can include storing the standardized prompt in a database.

In some instances, generating an enhanced avatar can include storing the standardized prompt as metadata with the enhanced avatar.

In some instances, the first generative AI model is a transformer-based model.

In some instances, the first generative AI model is a large language model (LLM).

According to a second aspect, one or more computer-readable storage media is provided. The one or more computer-readable storage media stores one or more instructions that, when executable by one or more computers, cause the one or more computers to perform the method according to the first aspect or one or more implementations of the first aspect.

According to a third aspect, a computer-implemented system is provided. The computer-implemented system includes one or more computers and one or more computer memory devices interoperably coupled with the one or more computers. The one or more computer memory devices have computer-readable storage media storing one or more instructions that, when executed by the one or more computers, perform the method according to the first aspect or one or more implementations of the first aspect.

While generally described as computer-implemented software embodied on tangible media that processes and transforms the respective data, some or all of the aspects can be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system for generating enhanced avatars.

FIG. 2 is a flowchart illustrating an example process for generating enhanced avatars.

FIG. 3 is a flowchart illustrating an example enhancement workflow used in enhancing avatars.

FIG. 4 is a flowchart illustrating an example process for cloning an enhanced avatar.

FIG. 5 is a flowchart illustrating the generation of an example enhanced avatar.

FIG. 6 illustrates a schematic diagram of an example computing system.

Like reference numbers and designations in the various drawings indicate like elements.

### DETAILED DESCRIPTION

This specification relates to methods, apparatuses, and systems for generating enhanced user avatars. Many social media and other digital platforms allow users to create or generate a custom avatar to represent themselves. Conventionally that avatar is a relatively static object, requiring generation of a new avatar to alter, enhance, or adjust. This disclosure provides users and developers with the ability to easily and rapidly update avatars based on, for example, circumstance, environment, or user desires.

Features disclosed herein enable users to express beyond the basic avatar or sticker set, react to a message in a unique way, and discover and collect interesting stickers/avatars (e.g. socially, trending memes, or from daily life).

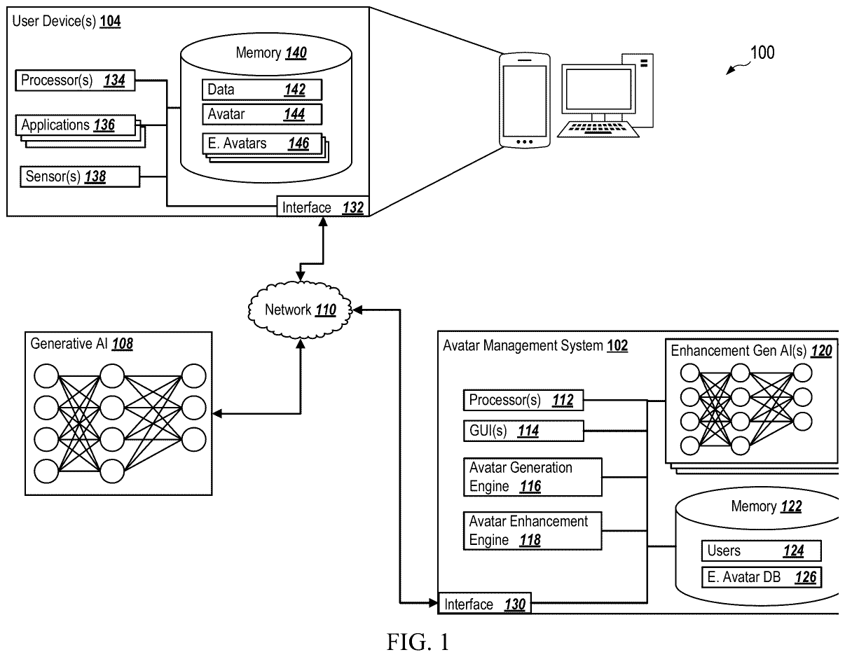

FIG. 1 illustrates a block diagram of an example system 100 for generating enhanced avatars. The system 100 includes an avatar management system 102, one or more user devices 104, and a generative artificial intelligence (AI) 108 which can communicate using a network 110.

Network 110 facilitates wireless or wireline communications between the components of the system 100 (e.g., between the avatar management system 102, the user devices 104, and the generative AI 108), as well as with any other local or remote computers, such as additional mobile devices, clients, servers, or other devices communicably coupled to network 110, including those not illustrated in FIG. 1. In the illustrated environment, the network 110 is depicted as a single network, but can comprise more than one network without departing from the scope of this disclosure, so long as at least a portion of the network 110 can facilitate communications between senders and recipients. In some instances, one or more of the illustrated components (e.g., the enhancement generative AIs 120 and the memory 122) can be included within or deployed to network 110 or a portion thereof as one or more cloud-based services or operations. The network 110 can be all or a portion of an enterprise or secured network, while in another instance, at least a portion of the network 100 can represent a connection to the Internet. In some instances, a portion of the network 110 can be a virtual private network (VPN). Further, all or a portion of the network 110 can comprise either a wireline or wireless link. Example wireless links can include 802.11a/b/g/n/ac, 802.20, WiMax, LTE, and/or any other appropriate wireless link. In other words, the network 110 encompasses any internal or external network, networks, sub-network, or combination thereof operable to facilitate communications between various computing components inside and outside the illustrated system 100. The network 110 can communicate, for example, Internet Protocol (IP) packets, Frame Relay frames, Asynchronous Transfer Mode (ATM) cells, voice, video, data, and other suitable information between network addresses. The network 110 can also include one or more local area networks (LANs), radio access networks (RANs), metropolitan area networks (MANs), wide area networks (WANs), all or a portion of the Internet, and/or any other communication system or systems at one or more locations.

The avatar management system 102 can be a server or web-based system that enables generation, enhancement storage and sharing of avatars and enhanced avatars between users and/or user devices 104. The avatar management system 102 can include one or more processors 112, graphical user interfaces (GUIs) 114, an avatar generation engine 116, an avatar enhancement engine 118, and a memory 122 storing user data 124 and an enhanced avatar database 126.

Each of the one or more processors 112 can be a central processing unit (CPU), an application specific integrated circuit (ASIC), a field-programmable gate array (FPGA), or another suitable component. Generally, the processor 112 executes instructions and manipulates data to perform the operations of the avatar management system 102. Specifically, the processor 112 executes the algorithms and operations described in the illustrated figures, as well as the various software modules and functionality, including the functionality for sending communications to and receiving transmissions from the generative AI 108, as well as to other devices and systems. Each processor 112 can have a single or multiple cores, with each core available to host and execute an individual processing thread. Further, the number of, types of, and particular processors 112 used to execute the operations described herein can be dynamically determined based on a number of requests, interactions, and operations associated with the avatar management system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Perl®, any suitable version of fourth-generation programming language (4GL), as well as others.

GUI 114 of the avatar management system 102 interfaces with at least a portion of the system 100 for any suitable purpose, including generating a visual representation of any particular application or results and/or the content associated with any components of the user devices 104. In particular, the GUI 114 can be used to present results of an avatar enhancement or allow the developer to input queries or prompts to the avatar management system 102, as well as to otherwise interact and present information associated with one or more applications. GUI 114 can also be used to view and interact with various web pages, applications, and web services located local or external to the avatar management system 102. Generally, the GUI 114 provides the user with an efficient and user-friendly presentation of data provided by or communicated within the system. The GUI 114 can include a plurality of customizable frames or views having interactive fields, pull-down lists, and buttons operated by the user. In general, the GUI 114 is often configurable, supports a combination of tables and graphs (e.g., bar, line, pie, and/or status dials), and is able to build real time portals, application windows, and presentations. Therefore, the GUI 114 contemplates any suitable graphical user interface, such as a combination of a generic web browser, a web-enable application, intelligent engine, and command line interface (CLI) that processes information in the platform and efficiently presents the results to the user visually.

Memory 122 can represent a single memory or multiple memories. The memory 122 can include any memory or database module and can take the form of volatile or non-volatile memory including, without limitation, magnetic media, optical media, random access memory (RAM), read-only memory (ROM), removable media, or any other suitable local or remote memory component. The memory 122 can store various objects or data, including digital asset data, public keys, user and/or account information, administrative settings, password information, caches, applications, backup data, repositories storing business and/or dynamic information, and any other appropriate information associated with the avatar management system 102, including any parameters, variables, algorithms, instructions, rules, constraints, or references thereto. Additionally, the memory 112 can store any other appropriate data, such as user profiles 124, avatars and enhanced avatars (e.g., enhanced avatar database 126), firmware logs and policies, firewall policies, a security or access log, print or other reporting files, as well as others. While illustrated within the system 100, memory 122 or any portion thereof, including some or all of the particular illustrated components, can be located remote from the system 100 in some instances, including as a cloud application or repository or as a separate cloud application or repository when the system 100 itself is a cloud-based system.

The avatar generation engine 116 can be used to create unique avatars based on an image or other input from a user. In some implementations, the avatar generation engine can receive user inputs such as menu selections, slider positions, and option selections from GUI 114, and generate a caricature or other graphical representation of a user. This avatar can be a baseline avatar that can be associated with the user profile 124 and be stored in memory 122. In some implementations, the baseline avatar visually represents the user, with similar hair color, facial features, apparel (e.g., glasses, clothing, and accessories) and is used as a profile picture or in combination with other expressive features of an internet platform (e.g., as emojis, stickers, or reaction icons). In some implementations, the avatar generation engine 116 can generate a baseline avatar in response to receiving an image of the user (e.g., a selfie) that was recorded by a user device 104. This image can be provided as input to one or more machine learning models or generative AI's, such as an enhancement generative AI 120 to produce a representative image. In some implementations, the baseline avatar is a cartoonized or simplified representation. In some implementations, the baseline avatar can be a photorealistic avatar that is controlled for pose, positioning, or stylized according to the parameters of the enhancement generative AIs 120.

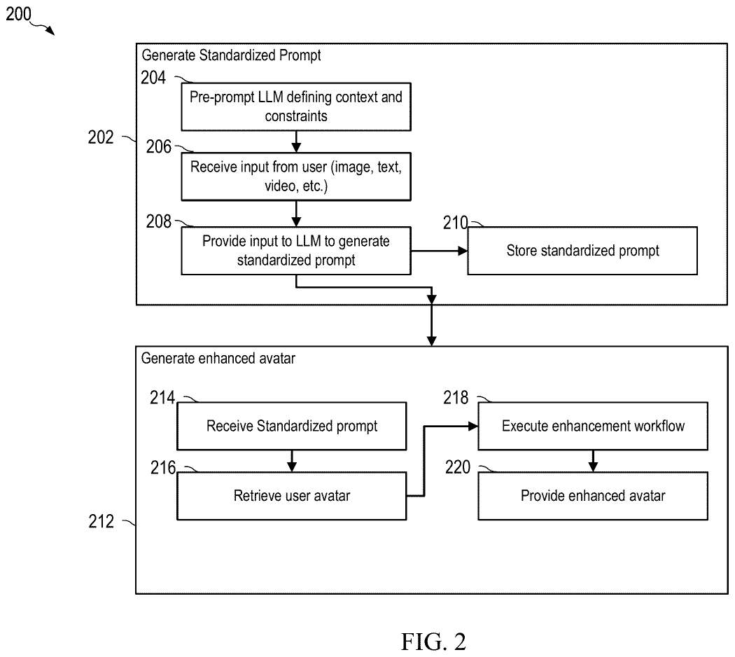

Avatar enhancement engine 118 can be used by a user device 104, via one or more graphical user interfaces 114 to modify, or enhance a baseline avatar. In general, the avatar enhancement engine 118 can receive an input from the user devices 104, which can be text, image, or other format (e.g., video), and constructs an enhanced avatar using a generative AI model 108 and a workflow utilizing one or more enhancement generative AI models 120. This process is described in more detail below with respect to FIGS. 2 through 5.

The enhancement generative AIs 120 can be a series of neural networks or other AI models that are used to generate the enhanced avatars. The enhancement generative AI models 120 can be, for example, diffusion models, low-rank adaptation (LoRA) models, ControlNet models, rule engines, scripts, and other models that are called and/or executed by the Avatar Enhancement engine 118. While illustrated as within avatar management system 102, in some implementations, the enhancement generative AIs 120 are remote from the avatar management system 102 and communicate using network 110 and various protocols such as application programming interfaces (APIs).

The enhanced avatar database 126 can store previously generated enhanced avatars, as well as metadata associated with those avatars such as the prompt used to create them, their relative popularity, engagement, number of shares, or other things. In some implementations, the enhanced avatar database 126 can be exposed to other systems and components, such as applications 136 of user devices 104, where it can be represented as a marketplace for sharing, purchasing, publishing, or editing enhanced avatars.

Interface 130 is used by the avatar management system 102 to communicate with other systems in a distributed environment - including within the system 100 - connected to the network 110 (e.g., user devices 104, and other systems communicably coupled to the illustrated avatar management system 102 and/or network 110. Generally, the interface 130 includes logic encoded in software and/or hardware in a suitable combination and operable to communicate with the network 110 and other components. More specifically, the interface 130 can include software supporting one or more communication protocols associated with communications such that the network 110 and/or interface's 130 hardware is operable to communicate physical signals within and outside of the illustrated system 100. Still further, the interface 130 can allow the avatar management system 102 to communicate with the generative AI 108, user devices 104, and/or other portions illustrated within the system 100 to perform the operations described herein.

Generative AI 108 can be used to structure the input from a user device 104 into a more suitable input for the avatar enhancement engine 118 to use with the enhancement generative AIs 120. In some implementations, Generative AI 108 can include one or more machine learning algorithms and/or neural networks trained to provide structured prompts and analysis of the received user input. In some implementations, the generative AI 108 is a large language model (LLM).

Generally, machine learning can include three phases. For example, a training phase, a testing phase, and an application phase (also referred to as an inference phase). In the training phase, a given model may be trained by using a large amount of training data, updating parameter values, for example, constantly and iteratively until the model obtains consistent reasoning that meets expected goals from the training data. By training, the model may be considered as being able to learn an association between input and output from training data (also referred to as mappings of input to output). Parameter values of the trained model are determined. In the testing stage, a test input is applied to the trained model, so as to test whether the model can provide a correct output, thereby determining the performance of the model. Sometimes, the testing phase may be fused in the training phase. In the application or inference phase, the trained model may be configured to process actual model input based on the trained parameter value to determine corresponding model output.

The generative AI 108 can include one or more neural networks. A “neural network” can be a deep learning-based machine learning network. The neural network processes inputs and provides respective outputs, which typically include an input layer and an output layer and one or more hidden layers between the input layer and the output layer. Neural networks used in deep learning applications can often include many hidden layers, increasing the depth of the network. Each layer of the neural network can be connected in sequence such that the output of the previous layer is provided as an input to the next layer, where the input layer receives the input of the neural network, and the output of the output layer serves as the final output of the neural network. Each layer of the neural network includes one or more nodes (also referred to as processing nodes or neurons), each node processing input from the previous layer.

The generative AI 108 can be deployed within the avatar management system 102 or may be deployed on other devices (e.g., remotely as illustrated). The generative AI 108 may be based on any suitable model structure including, but not limited to, a Transformer model, a convolutional neural network (CNN), a recurrent neural network (RNN), a deep neural network (DNN), or the like. In some implementations, the generative AI 108 may be based on a language model (LLM). In some implementations, the generative AI is a commercially available LLM or another specifically designed or trained generative AI model. In some implementations, the generative AI 108 is pretrained on avatars 144, the enhanced avatar database 126 or other resources to respond to the avatar enhancement engine 118 in the requested format and with information according to the prompt provided by the avatar enhancement engine 118.

User devices 104 can be computing devices or computers used by one or more users and developers of the software and hardware within system 100. For example, the user devices 104 can interact with the avatar management system 102 to request generation of new avatars or enhance a particular existing avatar. As used in the present disclosure, the term “computer” or “computing devices” is intended to encompass any suitable processing device. For example, the user devices 104 can be any computer or processing device such as, for example, a blade server, general-purpose personal computer (PC), Mac® workstation, UNIX-based workstation, or any other suitable device. In other words, the present disclosure contemplates computers other than general-purpose computers, as well as computers without conventional operating systems. The user devices 104, in some instances, can be desktop systems, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The user devices 104 can include one or more specific applications 136 executing on the user devices 104, or the user devices 104 can include one or more Web browsers or web applications that can interact with particular applications executing remotely from the user devices 104. User devices 104 can include a memory 140, which can be similar to or different from memory 122 and can store device data 142, the user's baseline avatar 144, as well as enhanced avatars 146 that have been previously generated. The user devices 104 can include an interface 132 which enables communication with other components of system 100, and can be similar to interface 130.

In some implementations, one or more sensors 138 can be associated with user devices 104 and can measure physical parameters to provide additional inputs to the avatar management system 102. For example, the user devices 104 may include one or more cameras that generate images, accelerometers that record movement or poses, and/or GPS receivers to identify locations.

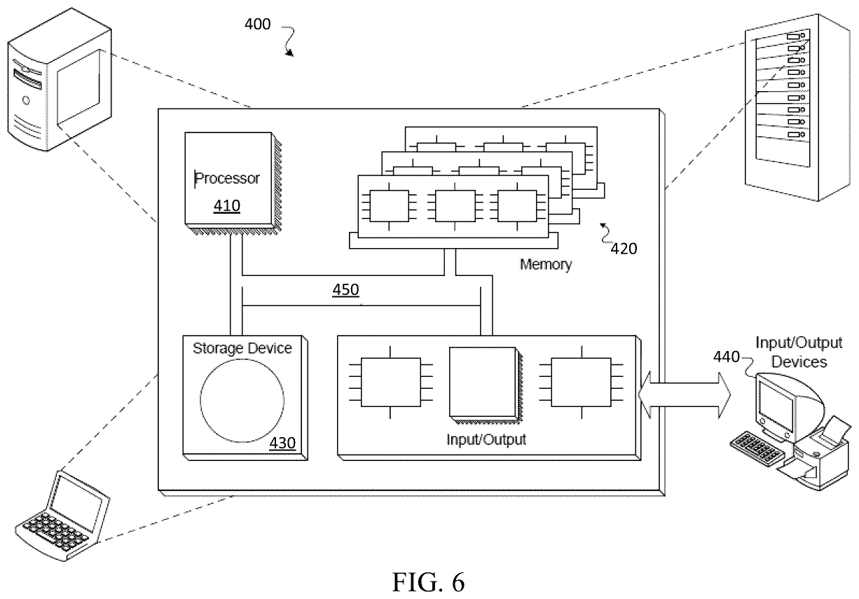

FIG. 2 is a flowchart illustrating an example process 200 for generating enhanced avatars. The example process 200 can be performed by a system for example, system 100 as described above with respect to FIG. 1. The operations shown in process 200 may not be exhaustive and other operations can be performed as well before, after, or in between any of the illustrated operations. Further, some of the operations may be performed simultaneously, or in a different order than shown in FIG. 2. In some implementations, some of the operations may be performed by a computer, or multiple computers. The one or more computers the process 200 will be described as being performed by a system of, located in one or more locations, and programmed appropriately in accordance with this specification. For example, one or more of a computation system 600 of FIG. 6, appropriately programmed, can perform the process 200.

At 202, a standardized prompt is generated based on a user input. This process can include operations 204 through 210, as well as additional operations, and can be performed, for example, by avatar enhancement engine 118 as described above with respect to FIG. 1.

At 204, a first generative AI, which can be a large language model (LLM) is pre-prompted to define the desired output and constraints. In some implementations, the pre-prompt describes for example, that the LLM is to provide a prompt for an image generation workflow that describes the received input in detail in order to produce a clean enhanced avatar from a baseline avatar. In some implementations the pre-prompt includes additional requirements such as token limits, image size, descriptive paragraphs, and other things. For example, a pre-prompt can be: “please provide me a prompt that is based on this image. Focus on describing poses, lighting, and expression.”

At 206, an input is received from the user, the input indicating an enhancement to be made on a baseline avatar. In some implementations, the input is text (e.g., “put me in an aggressive boxing pose”). In some implementations, the input is an image (e.g., a picture of a famous boxer). In some implementations, the input is a video or video clip (e.g., a GIF file of a boxer throwing punches). In implementations where the input includes video, keyframes or portions a subset of the frames used to make the video can be used to reduce the input size and increase the processing speed of the LLM. In some implementations, the input is a combination of media (e.g., text and image or video and image). In some implementations, the input can be pre-processed to streamline or improve the quality of return from the LLM. For example, images can be denoised, or have some of all of a background removed. Text inputs can be auto corrected for spelling or grammatical errors.

At 208, The user input is provided to the pre-prompted LLM in order to generate a standardized prompt. In some implementations, a local application (e.g., avatar enhancement engine 118 of FIG. 1) accesses an API of a commercially available LLM (e.g., Google Gemini, ChatGPT, or Claude). In some implementations, a custom-trained or local LLM is used. The LLM can return a standardized prompt, which will be used in image generation to produce the enhanced avatar.

At 210, The prompt generated by the LLM is stored. In some implementations, the prompt is stored in a database and will be associated with the enhanced avatar upon generation. In some implementations, the prompt is stored as metadata, which can be attached to the enhanced avatar at a later time. Storing the standardized prompt enables sharing of enhanced avatars, and regeneration of different enhanced avatars based on different baseline avatars using the same prompt.

At 212, an image generation workflow is executed in order to produce the enhanced avatar. This workflow can include operations 214, 216, 218, and 220.

At 214, The standardized prompt is received from the LLM. In some implementations, it is scanned to ensure it comports with the requirements of the image generation process (e.g., is not too large and/or does not contain profanity).

At 216, the user requesting the enhancement's baseline avatar is retrieved. This baseline avatar can be stored with the user profile, or in a web-based database. In some implementations, the baseline avatar is pre-existing. In some implementations, the user can be prompted to generate a new baseline avatar at 216, in which case the new baseline avatar can be used for enhancement.

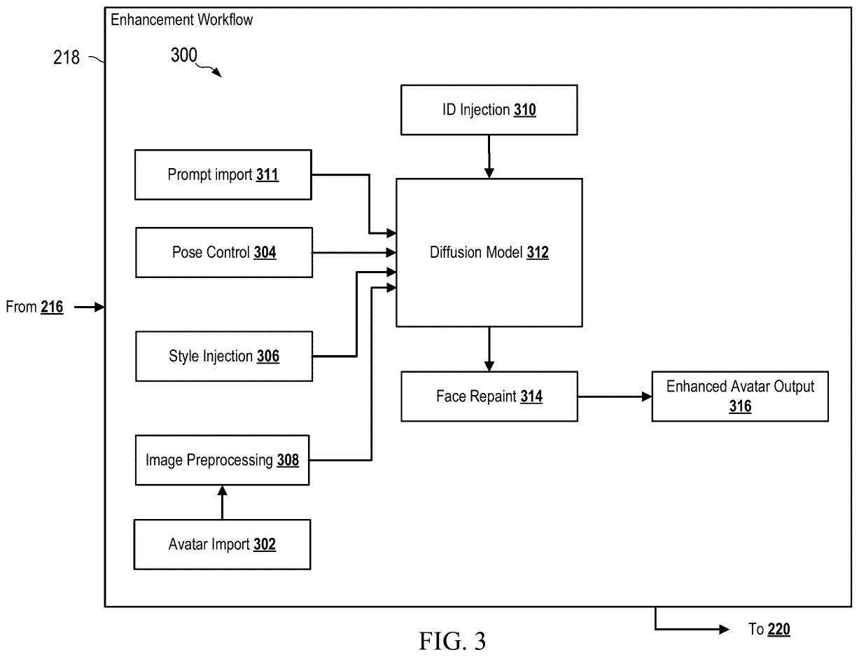

At 218, an enhancement workflow is executed using the baseline avatar and the standardized prompt. In some implementations, the enhancement workflow includes multiple generation models including diffusion models, ControlNet models, LoRAs, custom models, data processing models, or other generation models. The enhancement workflow is discussed in more detail below with respect to FIG. 3.

At 220, the generated enhanced avatar is provided to the user. This can be presented in a GUI (e.g., GUI 114 of FIG. 1), and stored in a database for future reference. In some implementations, the enhanced avatar is provided in a social marketplace, where it can be shared, liked, purchased, customized, re-generated, or otherwise interacted with.

FIG. 3 is a flowchart illustrating an example enhancement workflow used in enhancing avatars. The example process 300 can be performed by a system for example, avatar management system 102 as described above with respect to FIG. 1. The operations shown in process 300 may not be exhaustive and other operations can be performed as well before, after, or in between any of the illustrated operations. Further, some of the operations may be performed simultaneously, or in a different order than shown in FIG. 3. In some implementations, some of the operations may be performed by a computer, or multiple computers. The one or more computers the process 300 will be described as being performed by a system of, located in one or more locations, and programmed appropriately in accordance with this specification. For example, one or more of a computation system 600 of FIG. 6, appropriately programmed, can perform the process 300.

At 302, the user's baseline avatar is imported. This can be done using an API or by sending a request to the user device, or by fetching from a database. In some implementations, importing the baseline avatar includes extracting information from the avatar or metadata associated with the avatar, such as pose information, facial features, expression information, and other things.

At 304, a ControlNet is used to inject pose guidance into the diffusion model (312). The ControlNet can provide a skeleton or wireframe model to the diffusion model in order to bias the diffusion model toward a particular pose (e.g., a portrait headshot). In some implementations the pose is generated by the ControlNet using the standardized prompt. In some implementations, the pose can be predetermined, e.g., by developers or based on a user selection. In some implementations, the pose is generated based on the baseline avatar.

At 306, a low-rank adaptation module is used to inject a particular style into the diffusion model. This module learns a low-rank representation of the desired style, capturing its essence with a small set of parameters. This low-rank representation is then used to adapt the diffusion model's behavior, guiding the image generation process towards the target style. Target styles can be, for example, animated, cartoonized, clean, simple, hand drawn, painted, or glossy. Using style injection in this matter can ensure that there is some uniformity of style between various enhanced avatars, to enable more predictable results and better outputs.

At 308, image preprocessing occurs. This can be taking the imported avatar image and removing the background or other unnecessary components (e.g., clothing or accessories) to simplify the input and provide more consistent and accurate outputs. In some implementations, this is performed using computer vision processes such as color-based segmentation, edge detection, contour analysis, depth information, or other processes. In some implementations, a neural network is used to remove the background data.

At 310, the user's identity is injected into the diffusion model. In some implementations, the user's identity includes facial features, facial structure, physique, and other personal parameters (e.g., skin tone or gender) that are injected into the diffusion model to improve the accuracy of the image generation such that the enhanced avatar reflects the baseline avatar, and thus the user. In some implementations, the ID injection process uses a pre-trained facial recognition model to extract ID information. This ID information can be, but is not limited to, hair shape, facial features, outfit, accessories, height, expression, or others.

At 311, The standardized prompt (e.g., from 202 of FIG. 2) is imported. This prompt can be a text prompt that includes multiple sentences or phrases and describes the desired final image of the diffusion model.

At 312, a diffusion model takes the injected ID information, pose control information, style information, and preprocessed image, and generates an output image. In general, a diffusion model generates an image by iteratively denoising an input which can be a white noise, or random noise input. In some implementations, the aforementioned injections condition the diffusion model to direct the denoising process into a particular output. While the illustrated example uses a diffusion model, other image generation techniques are possible. For example, generative adversarial network (GAN) models, variational autoencoder networks (VAEs), or transformer based networks can be used to generate images.

At 314, a face repaint process can be performed on the output of the diffusion model. In some implementations, the face repaint is a ControlNet that uses data from the ID injection (310) or the original baseline avatar to ensure that the face of the generated image matches the user.

At 316, The final enhanced avatar is output. This enhanced avatar can be stored in a local database, remote database, and have additional information appended to it, such as the standardized prompt, baseline avatar, model weights and parameter values, or other metadata.

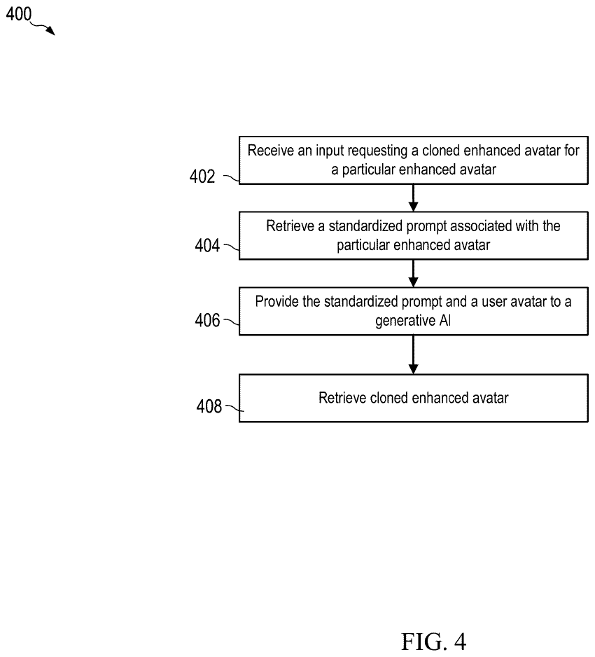

FIG. 4 is a flowchart illustrating an example process for cloning an enhanced avatar. The example process 400 can be performed by a system for example, avatar management system 102 as described above with respect to FIG. 1. The operations shown in process 400 may not be exhaustive and other operations can be performed as well before, after, or in between any of the illustrated operations. Further, some of the operations may be performed simultaneously, or in a different order than shown in FIG. 4. In some implementations, some of the operations may be performed by a computer, or multiple computers. The one or more computers the process 300 will be described as being performed by a system of, located in one or more locations, and programmed appropriately in accordance with this specification. For example, one or more of a computation system 600 of FIG. 6, appropriately programmed, can perform the process 400.

At 402, an input is received requesting a particular enhanced avatar be cloned. For example, a user may see an enhanced image of a second user's avatar in a boxing pose. That user may request an enhanced avatar that includes their avatar in a similar boxing pose, or a “clone” of the second user's enhanced avatar.

At 404, the standardized prompt associated with the particular enhanced avatar is retrieved. In some implementations, the standardized prompt is retrieved from the enhanced avatar itself. In some implementations, it is retrieved from a database of enhanced avatars and their associated standardized prompts.

At 406, The standardized prompt and the baseline avatar of the user requesting the cloning can be provided to a generative AI to generate the cloned enhanced avatar. In some implementations, the baseline avatar and standardized prompt are provided to an enhancement workflow similar to enhancement workflow 218 as described above with reference to FIGS. 2 and 3.

At 408, the cloned enhanced avatar is provided for consumption by the user. In some implementations it is provided in a graphical user interface that is interactive, enabling user feedback. In some implementations, the cloned enhanced avatar is stored in a database.

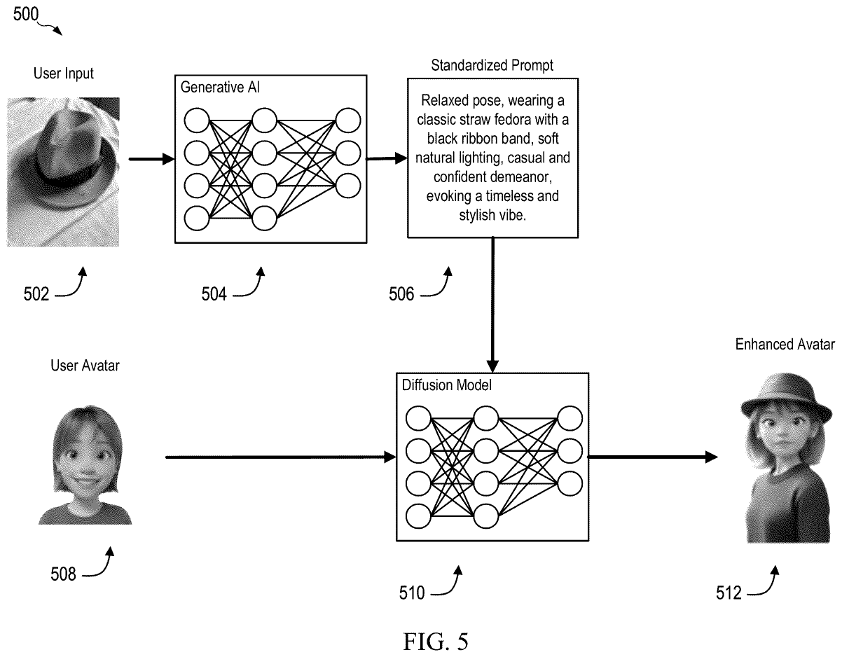

FIG. 5 is a flowchart illustrating the generation of an example enhanced avatar. Process 500 represents a simplified example illustrating one of many possible use cases for enhancing avatars. Process 500 is presented as a conceptual example only and is not intended to be limiting in any way.

At 502, the user has provided an input image. The input image is a picture of a fedora.

At 504, The input image is passed to a generative AI, such as a LLM to generate a standardized prompt for image creation. In some implementations, the generative AI is pre-prompted or conditioned to provide a prompt output suitable for image generation.

At 506, a standardized prompt is retrieved from the generative AI based on it's analysis of the user input (image of a fedora). The standardized prompt describes the image, and based on the pre-prompt, how the image should be combined with an avatar to make an enhanced avatar. For example, the standardized prompt describes the fedora in the user image, but it also includes terms such as “relaxed pose” and “casual and confident demeanor”, which describe a style for the image generator to use when providing an avatar with a fedora.

At 508, the user's avatar is retrieved. The user avatar can be a self-generator, AI generated, or selection-based generation. In the illustrated example, the user avatar is a simplified 3D representative portrait of the user in an animated style.

At 510, a diffusion model uses the user's avatar, and the standardized prompt to generate an enhanced image. The diffusion model can use one or more additional models (e.g., LoRAs, or ControlNets) to provide a consistent and high quality output.

At 512, the enhanced avatar is produced. It shows the user avatar, but in a pose and wearing a fedora as described in the standardized prompt. In some implementations, these enhanced avatars are capable of being copied or cloned for other users, shared, liked or endorsed, combined with other avatars, and otherwise interacted with by the user.

FIG. 6 illustrates a schematic diagram of an example computing system 600. The system 600 can be used for the operations described in association with the implementations described herein. For example, the system 600 may be included in computing devices of the one or more online components and/or the one or more offline components. The system 600 includes a processor 610, a memory 620, a storage device 630, and an input/output device 640, which are interconnected using a system bus 650. The processor 610 is capable of processing instructions for execution within the system 600. In some implementations, the processor 610 is a single-threaded processor. The processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. The memory 620 can be a volatile memory unit or a non-volatile memory unit. The storage device 630 is capable of providing mass storage for the system 600. The storage device 630 is a computer-readable medium. The storage device 630 may be a floppy disk device, a hard disk device, an optical disk device, or a tape device. The input/output device 640 provides input/output operations for the system 600. The input/output device 640 includes a keyboard and/or pointing device. The input/output device 640 includes a display unit for displaying graphical user interfaces.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship with each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required to be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations but should be defined only in accordance with the following claims and their equivalents. Accordingly, other implementations also are within the scope of the claims.

What is claimed is:

1. A computer-implemented method comprising:
receiving an input from a user requesting an enhanced avatar;
providing the input to a first generative AI model that is configured to output a standardized prompt based on the input;
receiving, from the first generative AI model, the standardized prompt;
identifying a baseline avatar associated with the user; and
providing the baseline avatar and the standardized prompt to an enhancement workflow to generate an enhanced avatar based on the standardized prompt and the baseline avatar.

2. The computer-implemented method of claim 1, wherein the enhancement workflow comprises:
a second generative AI model configured to provide the enhanced avatar as an image.

3. The computer-implemented method of claim 2, wherein the second generative AI model is a diffusion model and wherein the enhancement workflow comprises:
a low-rank adaptation (LoRA) model configured to provide stylization information to the second generative AI model;
a ControlNet model configured to condition the diffusion model to generate a particular pose based on the standardized prompt and the baseline avatar; and
a third generative AI model configured to repaint faces generated by second generative AI model, wherein the third generative AI model is a diffusion model.

4. The computer-implemented method of claim 1, comprising storing the standardized prompt in a database.

5. The computer-implemented method of claim 1, comprising storing the standardized prompt as metadata with the enhanced avatar.

6. The computer-implemented method of claim 1, wherein the first generative AI model is a transformer-based model.

7. The computer-implemented method of claim 1, wherein the first generative AI model is a large language model (LLM).

8. One or more computer-readable storage media storing one or more instructions that, when executable by one or more computers, cause the one or more computers to perform operations comprising:
receiving an input from a user requesting an enhanced avatar;
providing the input to a first generative AI model that is configured to output a standardized prompt based on the input;
receiving, from the first generative AI model, the standardized prompt;
identifying a baseline avatar associated with the user; and
providing the baseline avatar and the standardized prompt to an enhancement workflow to generate an enhanced avatar based on the standardized prompt and the baseline avatar.

9. The computer-readable storage media of claim 8, wherein the enhancement workflow comprises:
a second generative AI model configured to provide the enhanced avatar as an image.

10. The computer-readable storage media of claim 9, wherein the second generative AI model is a diffusion model and wherein the enhancement workflow comprises:
a low-rank adaptation (LoRA) model configured to provide stylization information to the second generative AI model;
a ControlNet model configured to condition the diffusion model to generate a particular pose based on the standardized prompt and the baseline avatar; and
a third generative AI model configured to repaint faces generated by second generative AI model, wherein the third generative AI model is a diffusion model.

11. The computer-readable storage media of claim 8, the operations comprising storing the standardized prompt in a database.

12. The computer-readable storage media of claim 8, the operations comprising storing the standardized prompt as metadata with the enhanced avatar.

13. The computer-readable storage media of claim 8, wherein the first generative AI model is a transformer-based model.

14. The computer-readable storage media of claim 8, wherein the first generative AI model is a large language model (LLM).

15. A computer-implemented system, comprising:
one or more computers; and
one or more computer memory devices interoperably coupled with the one or more computers and having computer-readable storage media storing one or more instructions that, when executed by the one or more computers, perform one or more operations comprising:
receiving an input from a user requesting an enhanced avatar;
providing the input to a first generative AI model that is configured to output a standardized prompt based on the input;
receiving, from the first generative AI model, the standardized prompt;
identifying a baseline avatar associated with the user; and
providing the baseline avatar and the standardized prompt to an enhancement workflow to generate an enhanced avatar based on the standardized prompt and the baseline avatar.

16. The system of claim 15, wherein the enhancement workflow comprises:
a second generative AI model configured to provide the enhanced avatar as an image.

17. The system of claim 16, wherein the second generative AI model is a diffusion model and wherein the enhancement workflow comprises:
a low-rank adaptation (LoRA) model configured to provide stylization information to the second generative AI model;
a ControlNet model configured to condition the diffusion model to generate a particular pose based on the standardized prompt and the baseline avatar; and
a third generative AI model configured to repaint faces generated by second generative AI model, wherein the third generative AI model is a diffusion model.

18. The system of claim 15, the operations comprising storing the standardized prompt in a database.

19. The system of claim 15, the operations comprising storing the standardized prompt as metadata with the enhanced avatar.

20. The system of claim 15, wherein the first generative AI model is a transformer-based model.
